(19) United States
(12) Patent Application Publication
(10) Pub. No.: US 2025/0342216 A1
(43) Pub. Date: Nov. 6, 2025

(54) INSTRUMENTATION AND METRICS COMBINING SEARCH ENGINE FOR OPTIMIZED OBSERVABILITY

(71) Applicant: Cisco Technology, Inc., San Jose, CA (US)

(72) Inventors: Jason Cade Davis, Apex, NC (US); Ming Zhu, Suzhou (CN); Haihua Xiao, Shanghai (CN); Xilai Tong, Kunshan (CN); Rizhi Chen, Shanghai (CN)

(73) Assignee: Cisco Technology, Inc., San Jose, CA (US)

(21) Appl. No.: 18/931,650

(22) Filed: Oct. 30, 2024

Related U.S. Application Data
(60) Provisional application No. 63/641,498, filed on May 2, 2024.

(51) Int. Cl. G06F 16/9532

(52) U.S. Cl. CPC G06F 16/9532

(57) ABSTRACT

In one implementation, a device may obtain a query specifying a metric of interest for network infrastructure. The device may search a repository of observability data to identify observability data associated with the metric of interest specified in the query. The device may generate output code providing protocol-specific implementation details for a management protocol associated with selected observability data for the metric of interest specified in the query. The device may provide the output code for export via a user interface.

### RELATED APPLICATION

This application claims priority to U.S. Prov. Appl. Ser. No. 63/641,498, filed May 2, 2024, entitled INSTRUMENTATION AND METRICS COMBINING SEARCH ENGINE FOR OPTIMIZED OBSERVABILITY, by Davis et al., the contents of which are incorporated herein by reference.

### TECHNICAL FIELD

The present disclosure relates generally to an instrumentation and metrics combining search engine for optimized observability.

### BACKGROUND

Information technology (IT) administrators and operators are tasked with keeping their network and services online, which they largely accomplish through network and service monitoring. While some administrators find enough functionality in commercial monitoring offerings by IT suppliers that provide common metrics such as CPU, memory and interface usage, and error rates, etc., others want more. For example, they want to extract operational status from their infrastructure and/or management applications to get new insights or to provide a competitive advantage; they want to build more bespoke dashboards leveraging more advanced metrics, etc. Achieving this may involve directly accessing the telemetry, instrumentation and metrics from the infrastructure and monitoring apps to extract those operational states.

Existing dashboard rendering solutions all have an integral preliminary requirement—the telemetry and metrics must be collected and provided into their database before they can graph or dashboard anything. They rarely have anything but the most basic instrumentation collectors and categories. The IT administrator/operator has the unenviable task of researching telemetry, instrumentation and metrics which can be spread across many sources. Finding, validating, and/or using these telemetry, instrumentation and metrics can be a struggle when spread across many sources. An admin/operator without detailed historical background, practical experience, and/or access to knowledgeable individuals and source material may struggle to even get started on the basic steps before they even build their first dashboard.

There are also well appointed, specific data-sources for APIs, different ones for YANG models, yet other different ones for SNMP MIBs and numerous ones for product command-line references. But focusing on any one of those may obscure the possibility of finding a solution with a different management protocol.

Assuming the admin/operator is successful finding a desired metric, they then must determine how to obtain or query the instrumentation or metric, which may involve varying authentication and payload creation steps. Only then the admin/operator can now normalize their data and put it into a database and use a graphing/dashboarding solution. These are too many preliminaries for most and stifle innovation and progress in ITOps.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture for searching and instrumenting observability metrics;

FIG. 5 illustrates an example of an interface of an instrumentation and metrics combining search engine; and

FIG. 6 illustrates an example of a simplified procedure for instrumentation and metrics combining searching for optimized observability, in accordance with one or more implementations described herein.

### DESCRIPTION OF EXAMPLE IMPLEMENTATIONS

### Overview

According to one or more implementations of the disclosure, a device may obtain a query specifying a metric of interest for network infrastructure. The device may search a repository of observability data to identify observability data associated with the metric of interest specified in the query. The device may generate output code providing protocol-specific implementation details for a management protocol associated with selected observability data for the metric of interest specified in the query. The device may provide the output code for export via a user interface.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

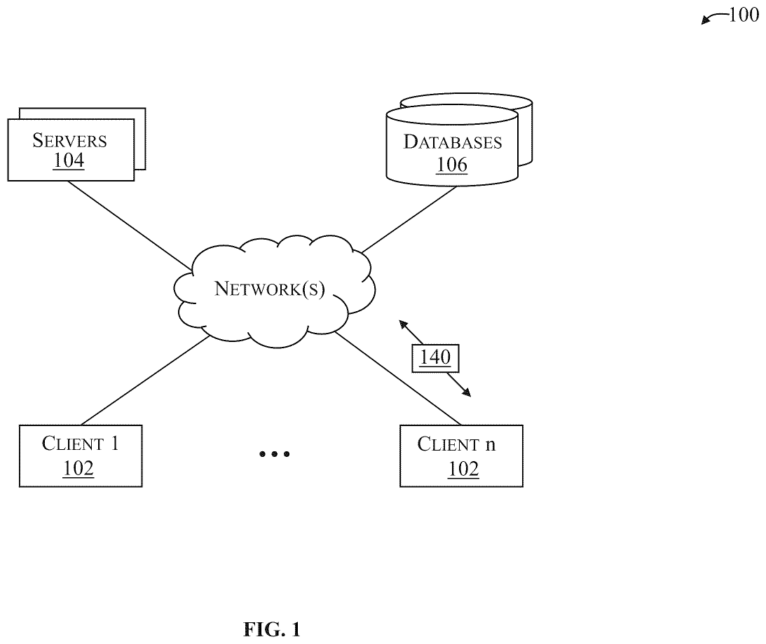

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

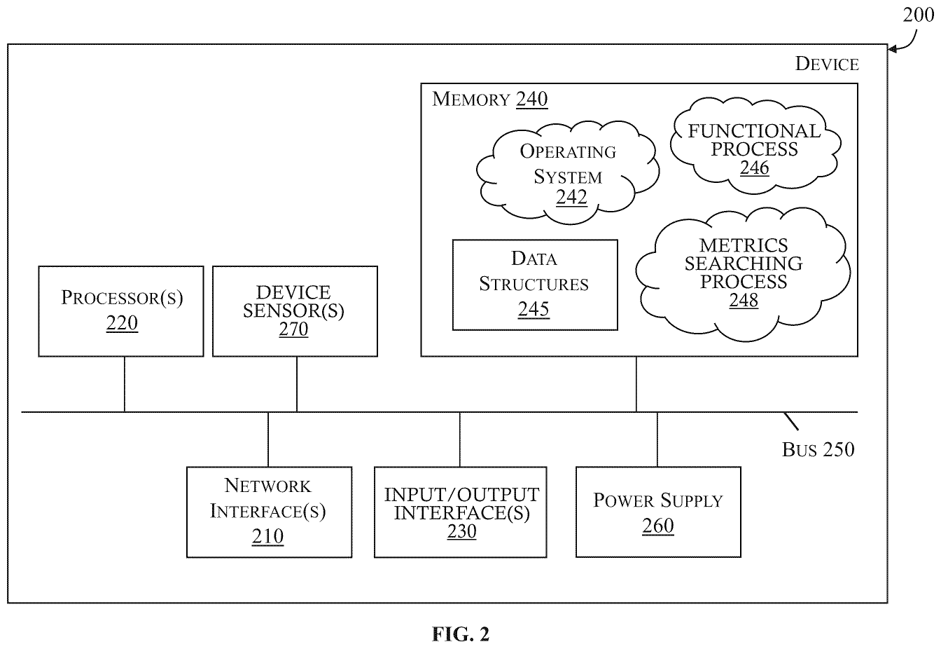

FIG. 2 is a schematic block diagram of an example of a node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

In various implementations, node/device 200 may include and/or be communicatively coupled with sensor(s) 270. That is, sensor(s) 270 may be integrated within node/device 200 and/or be a separate endpoint communicatively exposed to node/device 200. Sensor(s) 270 may include devices and/or modules that can detect changes in environmental and/or system conditions and transform these observations into machine and/or human readable signals. Examples of sensor(s) 270 may include, but are not limited to, temperature, humidity, fan speed, air quality, etc. sensors. In various instances, the telemetry data, metrics, instrumentation, etc. described herein may include sensor(s) 270 and/or the data collected by sensor(s) 270.

For example, if an IT administrator is searching for “what's the metric for showing the air quality sensor data?” utilizing the techniques described herein, a wireless access point including an embedded air quality sensor may exist and must be an exposed telemetry endpoint to be used to extract that data. Other instrumentation such as “number of active wireless clients,” last VPN user connect time,” “border gateway protocol (BGP) neighbor uptime,” etc. are additionally contemplated as available via data structures 245, functional processes 246, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as a metrics searching process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, metrics searching process 248 may include computer executable instructions that, when executed by processor 220, cause device 200 to perform the techniques described herein. To do so, in some implementations, metrics searching process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, metrics searching process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that metrics searching process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, metrics searching process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform, metrics searching process 248 may use a generative model to aggregate telemetry data into a searchable datastore that supports search parameter definition, refine the results, and obtain/generate a suggested code snippet that facilitates rapid metric identification and use, without additional ‘how-to-use’ research, based on a conversational input from a user (e.g., voice, text, etc.). Example generative approaches can include, but are not limited to, generative adversarial networks (GANs), large language models (LLMs), other transformer models, and the like.

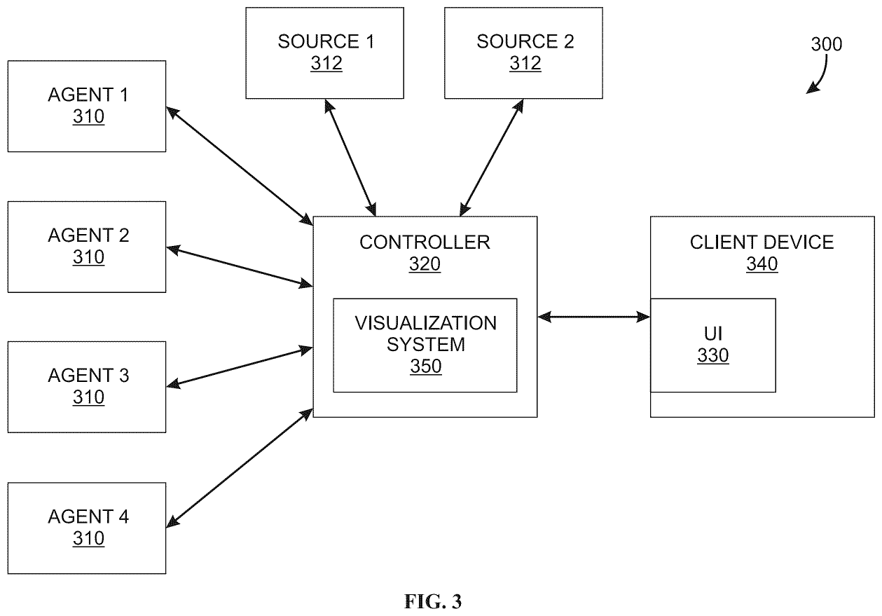

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, IT administrators and operators are tasked with keeping their network and services online, which they largely accomplish through network and service monitoring (e.g., utilizing observability intelligence platforms, etc.). Some administrators find enough functionality in commercial monitoring offerings by IT suppliers that provide common metrics such as CPU, memory and interface usage, and error rates, etc. However, others want more—they want to extract operational status from their infrastructure and/or management applications to get new insights or to provide a competitive advantage; they will want to build more bespoke dashboards leveraging more advanced metrics—BGP neighbor uptime, Wi-Fi 6e client count, IPv6 traffic volume, Kilowatt-hours of power consumed, etc. Achieving this may involve directly accessing the telemetry, instrumentation and metrics from the infrastructure and monitoring apps to extract those operational states.

There are many excellent dashboard rendering solutions, such as Power BI, Grafana, Kibana, Tableau, Redash, Charted, etc., however, they all have an integral preliminary requirement—the telemetry and metrics must be collected and provided into their database before they can graph or dashboard anything. They rarely have anything but the most basic instrumentation collectors and categories.

The IT administrator/operator has the unenviable task of researching telemetry, instrumentation and metrics which can be spread across many sources such as network management applications and their APIs, device instrumentation with yet another next generation (YANG) Models (network configuration protocol (NETCONF) remote procedure calls (RPC), gRPC streaming telemetry, etc.), device instrumentation with simple network management protocol (SNMP) management information bases (MIBs), legacy command-line output, etc.

Finding, validating, and/or using these telemetry, instrumentation and metrics can be a struggle when spread across many sources (e.g., Google search references, product docs, Github, etc.). An admin/operator without detailed historical background, practical experience, and/or access to knowledgeable individuals and source material will struggle to even get started on the basic steps before they even build their first dashboard.

There are also well appointed, specific data-sources for APIs, different ones for YANG models, yet other different ones for SNMP MIBs and numerous ones for product command-line references. But focusing on any one of those may obscure the possibility of finding a solution with a different management protocol.

Assuming the admin/operator is successful finding a desired metric, they then must determine how to obtain or query the instrumentation or metric, which may involve varying authentication and payload creation steps. Only then the admin/operator can now normalize their data and put it into a database and use a graphing/dashboarding solution. These are too many preliminaries for most and stifle innovation and progress in ITOps.

### —Instrumentation and Metrics Combining Search Engine for Optimized Observability—

In contrast, the techniques described herein simplify the user experience and provide IT administrators and/or operators with mechanisms to perform refined instrumentation and/or metric searches of various sources of telemetry, instrumentation, and metrics across different management protocols to rapidly obtain relevant code snippets. For example, the techniques described herein introduce a metrics search engine component that combines the various sources of telemetry, instrumentation, and metrics across different management protocols and facilitates a user in filtering and refining the search results of these sources to narrow the output to more desired results. Further, the techniques described herein introduce a code generator component to provide a sample of output code for a metric of interest selected from among the results.

Illustratively, the techniques described herein may be performed by hardware, software, and/or firmware, such as in accordance with metrics searching process 248, which may include computer executable instructions executed by the processor 220 (or independent processor of interfaces 210) to perform functions relating to the techniques described herein.

Specifically, according to various implementations, a device may obtain a query specifying a metric of interest for network infrastructure. The device may search a repository of observability data to identify observability data associated with the metric of interest specified in the query. The device may generate output code providing protocol-specific implementation details for a management protocol associated with selected observability data for the metric of interest specified in the query. The device may provide the output code for export via a user interface.

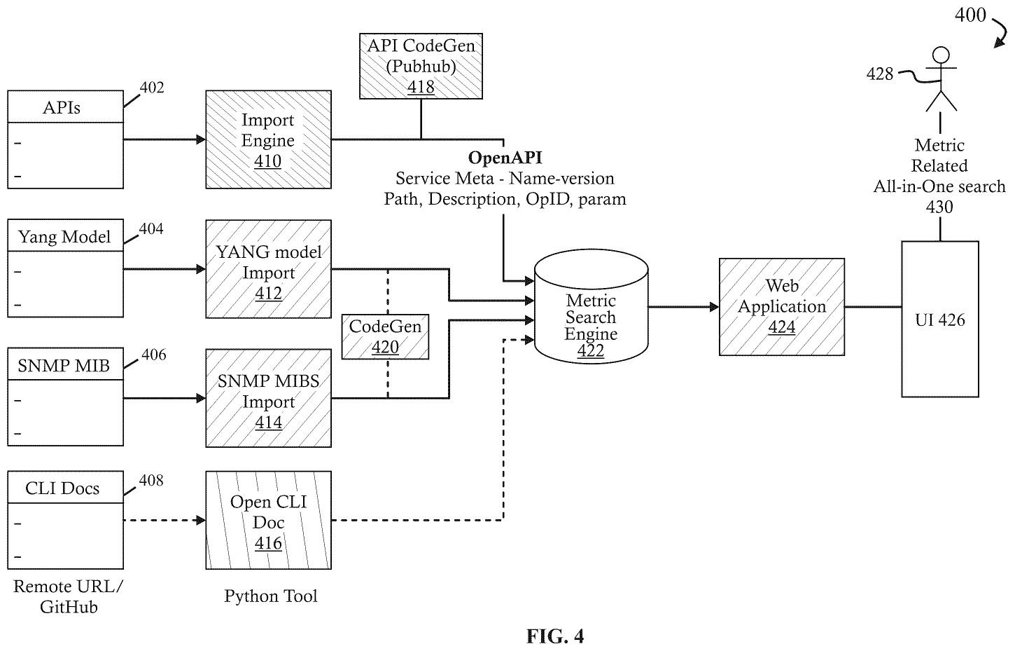

Operationally, FIG. 4 illustrates an example of an architecture 400 for searching and instrumenting observability metrics, in accordance with one or more implementations described herein. At the core of architecture 400 is metric search engine 422 which may be configured to combine the various sources of telemetry, instrumentation, and/or metrics across different management protocols. In a modular sense, metric search engine 422 may perform its searching across various data sources such as, but not limited to, APIs 402, one or more YANG models 404, SNMP MIBs 406, CLI documents 408, or the like. As would be appreciated, the components shown in FIG. 4 are illustrative only and their functions may be combined or omitted in other implementations, as desired. In addition, these components may be executed in a distributed manner, in one implementation, in which case the set of executing devices may be viewed as a singular device for purposes of the teachings herein.

With respect to APIs 402, devices and management applications with APIs are usually defined with Swagger, OpenAPI Spec (OAS), etc. Such documentation may indicate, for instance, the service metadata for a given API, its name and version, its path, its description, its OpID, its parameters, etc. To this end, architecture 400 may include an API import engine 410 that is responsible for ingesting those well-defined specifications into the back-end database of metric search engine 422. In some instances, API import engine 410 may also be configured to ingest non-Swagger/OAS documented APIs from provided HTML sources, as well.

With respect to the YANG model(s) 404, devices and management applications using YANG models with NETCONF, gRPC or gNMI methods may have a separate YANG model import engine 412 in architecture 400 that targets the Github repositories common for central documentation and auditing. During execution, YANG model import engine 412 may routinely scan the YANG model repositories to ensure the back-end database of metric search engine 422 has current data.

With respect to the SNMP MIBs 406, devices and management applications using SNMP MIBs may have a separate import engine 414 in architecture 400 that targets the Github repositories common for central documentation and auditing of SNMP MIBs and objects. To this end, import engine 414 may routinely scan the SNMP MIB repositories to ensure the back-end database of metric search engine 422 has current data.

With respect to the CLI documents 408, devices and management applications providing a command line (e.g., typically via SSH protocol) may also have a separate import engine 416 that parses web-based Command Reference documentation. To this end, import engine 416 may similarly scan this documentation (e.g., Open CLI documents) to ensure that that the back-end database of metric search engine 422 has current data.

These and/or other sources of truth may be combined into a big data lake of telemetry, instrumentation, and/or metrics that are searchable by metric search engine 422 for an administrator/operator to find specific results. The user may filter and refine the search results to narrow the output to more desired results. For instance, the filtering may support device operating system version, supported hardware platform, and/or supported YANG model or MIB.

In some implementations, a web application 424 may allow a user 428 to interact with metric search engine 422 via a user interface (UI) 426. For instance, user 428 may perform an all-in-one search 430 for a particular metric across all of the various sources available.

In various implementations, architecture 400 may further include one or more code generators configured to provide a code sample associated with a given answer. For instance, in the case of user 428 asking about a particular API, API code generator 418 may generate and provide a code sample calling that API as part of the answer from metric search engine 422. Similarly, a code generator 420 may provide a code sample in Python, or other language, that suggests the authentication method and any payload definition for that management protocol (e.g., sensor path, SNMP MIB object, command, etc.).

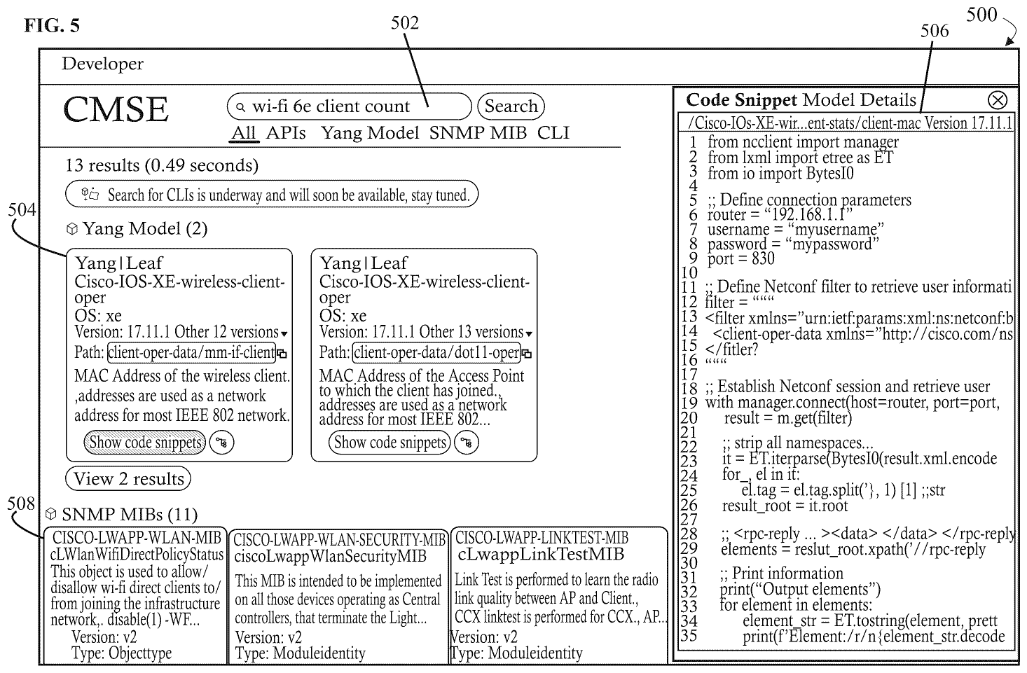

FIG. 5 illustrates an example of an interface 500 of an instrumentation and metrics combining search engine (e.g., metric search engine 422), in accordance with one or more implementations described herein. Often, developers want to introduce new dashboards, collect more unique metrics, and/or create a combination of data points to gain efficiency and competitive insights into network infrastructure. However, the telemetry and instrumentation in the network infrastructure are often locked away across a variety of product APIs, YANG models, SNMP MIBs and even command line output. The instrumentation and metrics combining search engine described herein provides a mechanism for providing an understanding of where to find these insights and/or how to use them.

The instrumentation and metrics combining search engine may leverage a purpose-built data lake of product APIs, public YANG models, SNMP MIBs, CLI command references, etc. to deliver the telemetry, instrumentation, metrics, etc. For example, a user may enter a search 502 for a metric of interest. Here, the search 502 is targeting “wi-fi 6e client counts” from access points and/or a wireless LAN controller. This search may return various options, such as YANG models 504, SNMP MIBs 508, or the like, that match the search. This is intended as a non-limiting example and search 502 may target any telemetry, instrumentation, metrics, etc. (e.g., BGP neighbor uptime, power supply wattage for sustainability metrics, the number of active logged-in users to the console, a temperature of devices, etc.).

More specifically, once the user enters search 502, the search engine may search the purpose-built data lake of product APIs, public YANG models, SNMP MIBs, CLI command references, etc. for telemetry, instrumentation, metrics, etc. associated with the metric of interest. The instrumentation and metrics combining search engine may provide matching results from the data lake for selection via a user interface.

As shown, another potential feature of the search engine is the ability of the user to select one or more of the matching results, such as to view one or more code snippets generated by the system. For instance, assume that the user has selected to view the code snippet 506 for a particular one of the YANG models 504 returned as part of the answer. In such a case, the user interface may then display the corresponding code snippet 506, which the user may use as the basis for various purposes such as input into context of monitoring, data storage, data visualization, etc. tools (e.g., InfluxDB, Grafana, etc.) for implementation, etc. of the functionality.

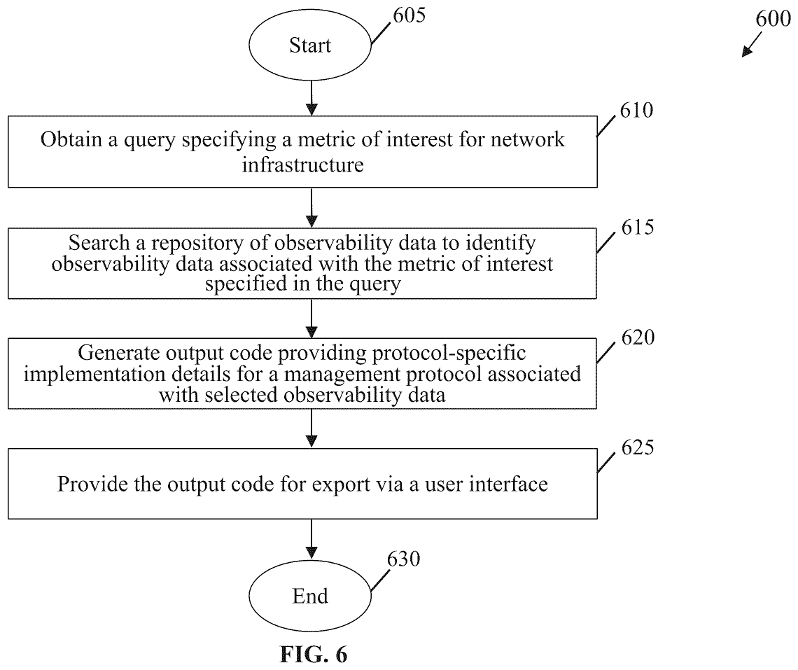

FIG. 6 illustrates an example of a simplified procedure for instrumentation and metrics combining searching for optimized observability, in accordance with one or more implementations described herein. For example, a non-generic, specifically configured device (e.g., device 200), may perform procedure 600 (e.g., a method) by executing stored instructions (e.g., metrics searching process 248).

The procedure 600 may start at step 605, and continues to step 610, where, as described in greater detail above, the device (e.g., a controller, processor, etc.) may obtain a query specifying a metric of interest for network infrastructure. The query may be obtained via entry to an instrumentation and metrics combining search engine user interface.

At step 615, as detailed above, the device may search a repository of observability data to identify observability data associated with the metric of interest specified in the query. The repository may be created and/or maintained by aggregating the observability data in the repository from various sources of telemetry, instrumentation, and metrics across different management protocols and/or updating the observability data in the repository responsive to updates to the various sources of telemetry, instrumentation, and metrics across the different management protocols.

The observability data in the repository of observability data may include command line reference specifications ingested from command line reference repositories. The observability data in the repository of observability data may include application programming interface specifications ingested from associated definitions. In some instances, the observability data in the repository of observability data may include YANG model specifications imported from YANG model repositories. In addition, the observability data in the repository of observability data may include simple network management protocol management information base specifications imported from simple network management protocol management information base specification repositories.

In various implementations, the observability data associated with the metric of interest may be refined to selectable observability data relevant to a specific platform. The selectable observability data relevant to the specific platform may include observability data compatible with one or more of an operating system version, a supported hardware platform, and/or a supported network data model associated with the network infrastructure.

At step 620, the device may generate output code providing protocol-specific implementation details for a management protocol associated with selected observability data for the metric of interest specified in the query. The protocol-specific implementation details may include an authentication method for the management protocol associated with the metric of interest specified in the query. Additionally, the protocol-specific implementation details may include a payload definition for the management protocol associated with the metric of interest specified in the query.

At step 625, the device may provide the output code for export via a user interface. The output code may be configured for communication and/or to be input to context of monitoring, data storage, data visualization, etc. tools, for implementation of their associated functionality.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, alleviate the frustration prevalent across users encountering diversity of network management telemetry with APIs, YANG models, SNMP MIBs and even CLI outputs as well as accelerating the stalled innovation occurring as network administrators and operators must search for the telemetry, instrumentation, and/or metrics that are important to their network operations across a wide variety of sources. These techniques may simplify the user experience by aggregating the telemetry into a searchable datastore that allows the user to define their search parameters, refine the results, and obtain a suggested code snippet that allows them to use the metrics more quickly, without additional ‘how-to-use’ research.

While there have been shown and described illustrative implementations that provide an instrumentation and metrics combining search engine for optimized observability, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
obtaining, by a device, a query specifying a metric of interest for network infrastructure;
searching, by the device, a repository of observability data to identify observability data associated with the metric of interest specified in the query;
generating, by the device, output code providing protocol-specific implementation details for a management protocol associated with selected observability data for the metric of interest specified in the query; and
providing, by the device, the output code for export via a user interface.

2. The method as in claim 1, further comprising:
refining the observability data associated with the metric of interest to selectable observability data relevant to a specific platform.

3. The method as in claim 2, wherein the selectable observability data relevant to the specific platform includes observability data compatible with one or more of an operating system version, a supported hardware platform, or a supported network data model associated with the network infrastructure.

4. The method as in claim 1, wherein the protocol-specific implementation details include an authentication method for the management protocol associated with the metric of interest specified in the query.

5. The method as in claim 1, wherein the protocol-specific implementation details include a payload definition for the management protocol associated with the metric of interest specified in the query.

6. The method as in claim 1, wherein the observability data in the repository of observability data includes command line reference specifications ingested from command line reference repositories.

7. The method as in claim 1, wherein the observability data in the repository of observability data includes application programming interface specifications ingested from associated definitions.

8. The method as in claim 1, wherein the observability data in the repository of observability data includes YANG model specifications imported from YANG model repositories.

9. The method as in claim 1, wherein the observability data in the repository of observability data includes simple network management protocol management information base specifications imported from simple network management protocol management information base specification repositories.

10. The method as in claim 1, further comprising:
aggregating the observability data in the repository from various sources of telemetry, instrumentation, and metrics across different management protocols; and
updating the observability data in the repository responsive to updates to the various sources of telemetry, instrumentation, and metrics across the different management protocols.

11. An apparatus, comprising:
one or more network interfaces;
a processor coupled to the one or more network interfaces and configured to execute one or more processes; and
a memory configured to store a process that is executable by the processor, the process when executed configured to:
obtain a query specifying a metric of interest for network infrastructure;
search a repository of observability data to identify observability data associated with the metric of interest specified in the query;
generate output code providing protocol-specific implementation details for a management protocol associated with selected observability data for the metric of interest specified in the query; and
provide the output code for export via a user interface.

12. The apparatus as in claim 11, the process when executed further configured to:
refine the observability data associated with the metric of interest to selectable observability data relevant to a specific platform.

13. The apparatus as in claim 12, wherein the selectable observability data relevant to the specific platform includes observability data compatible with one or more of an operating system version, a supported hardware platform, or a supported network data model associated with the network infrastructure.

14. The apparatus as in claim 11, wherein the protocol-specific implementation details include an authentication method for the management protocol associated with the metric of interest specified in the query.

15. The apparatus as in claim 11, wherein the protocol-specific implementation details include a payload definition for the management protocol associated with the metric of interest specified in the query.

16. The apparatus as in claim 11, wherein the observability data in the repository of observability data includes command line reference specifications ingested from command line reference specification repositories.

17. The apparatus as in claim 11, wherein the observability data in the repository of observability data includes application programming interface specifications ingested from associated definitions.

18. The apparatus as in claim 11, wherein the observability data in the repository of observability data includes YANG model specifications imported from YANG model specification repositories.

19. The apparatus as in claim 11, wherein the observability data in the repository of observability data includes simple network management protocol management information base specifications imported from simple network management protocol management information base specification repositories.

20. A tangible, non-transitory, computer-readable medium storing program instructions that cause a device to execute a process comprising:
obtaining a query specifying a metric of interest for network infrastructure;
searching a repository of observability data to identify observability data associated with the metric of interest specified in the query;
generating output code providing protocol-specific implementation details for a management protocol associated with selected observability data for the metric of interest specified in the query; and
providing the output code for export via a user interface.
